(19) United States
(12) Patent Application Publication
(10) Pub. No.: US 2025/0256538 A1
(43) Pub. Date: Aug. 14, 2025

(54) MULTI-CURRENT TRAILER CONNECTOR

(71) Applicant: VALCRUM, LLC, CYPRESS, TX (US)

(72) Inventor: Alton L. Shelton, III, Cypress, TX (US)

(73) Assignee: VALCRUM, LLC, CYPRESS, TX (US)

(21) Appl. No.: 19/045,084

(22) Filed: Feb. 4, 2025

Related U.S. Application Data
(60) Provisional application No. 63/551,986, filed on Feb. 9, 2024.

(51) Int. Cl. B60D 1/62; H01R 9/24; H01R 13/04; H01R 13/11; H01R 13/447

(52) U.S. Cl. CPC B60D 1/62; H01R 9/2491; H01R 13/04; H01R 13/111; H01R 13/447; H01R 2201/26

(57) ABSTRACT

A first assembly that has a non-conductive housing including a face plate that has an outer surface. A first socket extends behind the outer surface of the face plate and it has a plurality of terminals. The first assembly has a second socket with a terminal block. The terminal block has a sidewall that surrounds a plurality of terminal pins. The sidewall extends outward of the surface of the face plate in a direction opposite to that of the first socket. The terminal block is surrounded by a terminal block channel. The outer sidewall first telescopically contacts the sidewall of the terminal block then upon further sliding of the first and second assemblies beyond the first contact causes sliding contact of the outer sidewall between the sidewall of the terminal block and the second socket sidewall. After that and upon further sliding an electrical connection is made.

### CROSS REFERENCE TO RELATED APPLICATIONS

This application claims priority of U.S. Provisional application 63/551,986, filed Feb. 9, 2024, which application is hereby incorporated in its entirety by reference.

### BACKGROUND OF THE INVENTION

Vehicle connectors for transmitting electricity have existed for quite some time. Generally, such connectors have been low current and low voltage connections. However, modern vehicles can require significantly much more power across plugs and receptacles that are used to make electrical connections. Electrical vehicle chargers are an example of an electrical connection that is a high amperage and high voltage connection. The power across an electrical vehicle charger plugged into a vehicle presents a significant danger to any person who might come into contact with the conductors transmitting the power. As such, SAE J1772 provides a complicated and rather expensive way of protecting users of electric vehicle chargers through the design of the plug and receptacle. This standard includes a means for using a latch as part of the mechanism that disconnects power from the terminals of the plug that extends from a vehicle charger. The latching mechanism is a device that must be actuated to connect and disconnect the vehicle plug to the respective vehicle to be charged. This is an active mechanism that requires mechanical components to affirmatively make or break a circuit to the charging terminals in the charging plug.

Many trailer and recreational vehicle operators desire a plug and receptacle capable of transmitting low amperage and low voltage for trailer lights and also want the additional capacity to transmit high voltage and high amperage. Thus far, the complicated plugs in the industry for electrical vehicles cannot not satisfy that function, nor would traditional trailer connectors. Ideally, a plug carrying high amperage and high voltage would be well shielded from the environment and the user without separate mechanisms that can have the potential to fail and expose a user to a significant amount of electricity. There is an unmet need to have a vehicle plug that has the capacity to passively shield a user from the electricity it carries.

### SUMMARY OF THE INVENTION

The present invention includes a first assembly that has a non-conductive housing that includes a face plate that has an outer surface. A first socket extends behind the outer surface of the face plate. The first socket includes a plurality of terminals in a location that is offset from the outer surface of the face plate. This locates the terminals in a recessed location in the first socket with respect to the face plate. The first assembly includes a second socket within it that has a terminal block. The terminal block has a sidewall that surrounds a plurality of terminal pins. The sidewall extends outward of the outer surface of the face plate in a direction opposite to that of the first socket. The sidewall of the terminal block includes an outer end surface that is offset from the outer surface of the face plate in a direction opposite to that of the first socket. The terminal block is surrounded by a terminal block channel. The terminal block channel is defined by the sidewall of the terminal block and a second socket sidewall. The terminal block channel is spaced from the first socket.

A second assembly includes a non-conductive housing that has a plug block having an end surface. The plug block contains a group of terminals that has a plurality of terminals for providing electrical paths. The plug block has an outer wall having an inner surface and an outer surface. The outer wall ends at an end surface of the plug block. The outer wall of the second plug block is spaced from and surrounds a plurality of upstanding terminal bosses. Each of the terminal bosses terminates at an offset surface that is recessed from the end surface of the plug block. Each of the and surfaces of the terminal bosses includes an aperture. Each of the terminal bosses has a terminal adjacent to the aperture for contacting one of the terminal pins in the terminal block of the first assembly and this connection forms an electrical connection. The outer sidewall fits in complementary engagement over the terminal block of the first assembly when the second assembly is engaged with the first assembly. This substantially shields the terminal block when the second assembly is engaged with the first assembly The outer sidewall first telescopically contacts the sidewall of the terminal block when the second assembly is engaged with the first assembly for a first contact of the first and second assemblies. Further sliding of the first and second assemblies beyond the first contact causes sliding contact of the outer sidewall between the sidewall of the terminal block and the second socket sidewall for a second contact of the first and second assemblies. Still further sliding of the first and second assemblies beyond the second contact causes connection of the terminal pins and the terminals in the terminal bosses.

### BRIEF DESCRIPTION OF THE DRAWINGS

FIG. 1 is a perspective view of the receptacle;

FIG. 2 is a perspective view of the plug;

FIG. 3 is a sectional view of the receptacle through the center;

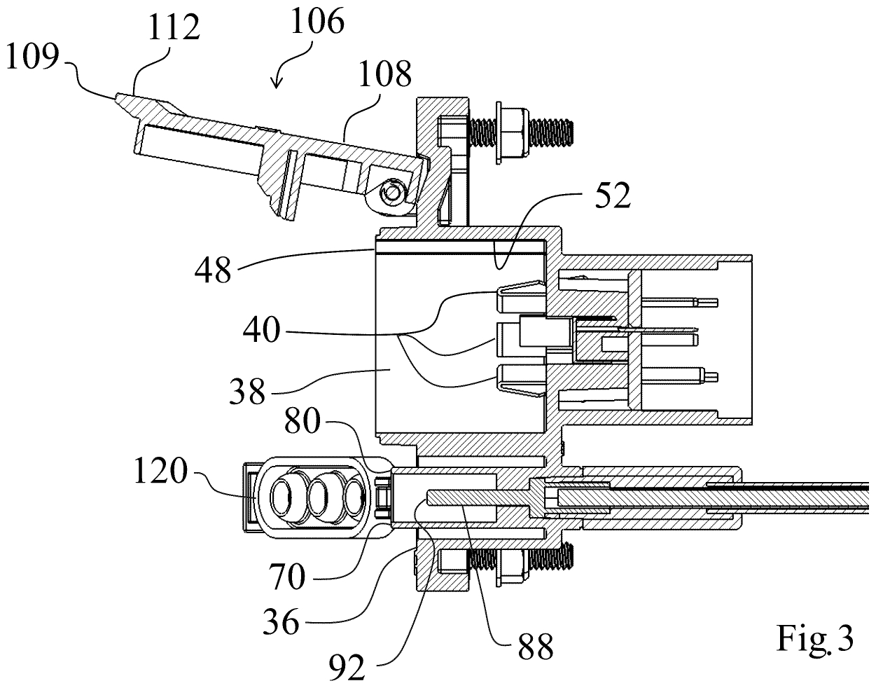

FIG. 4 is a sectional view of the plug through the center;

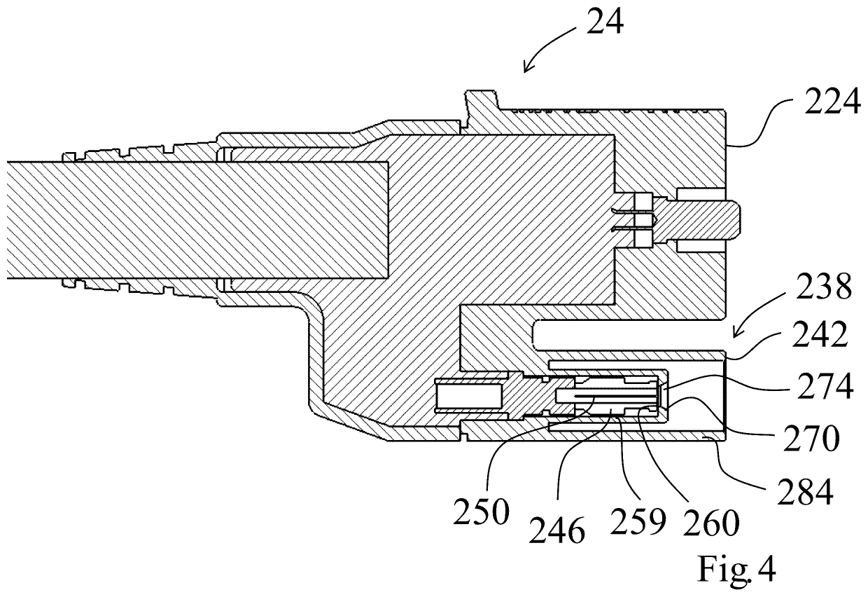

FIG. 5 is a sectional view of the plug inserted into the receptacle through the center of both with the second plug block sidewall between the terminal block and outer sidewall of the second socket;

FIG. 6 is a sectional view of the plug showing electrical contact in the second socket of the receptacle;

FIG. 7 is a sectional view of the plug in FIG. 6 showing the plug fully inserted into the receptacle; and

FIG. 8 is a sectional view of the plug in FIGS. 6 and 7 showing the plug making first contact with the terminal block in the second socket.

### DETAILED DESCRIPTION OF INVENTION

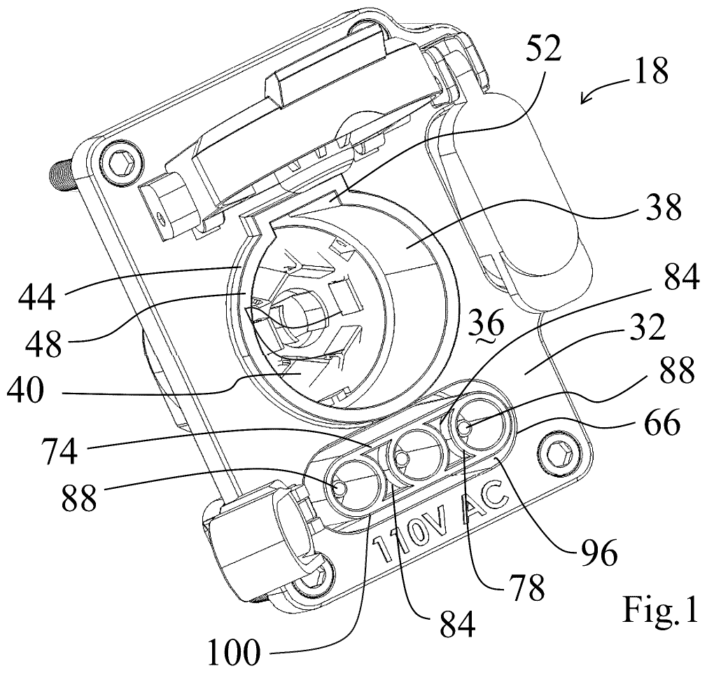

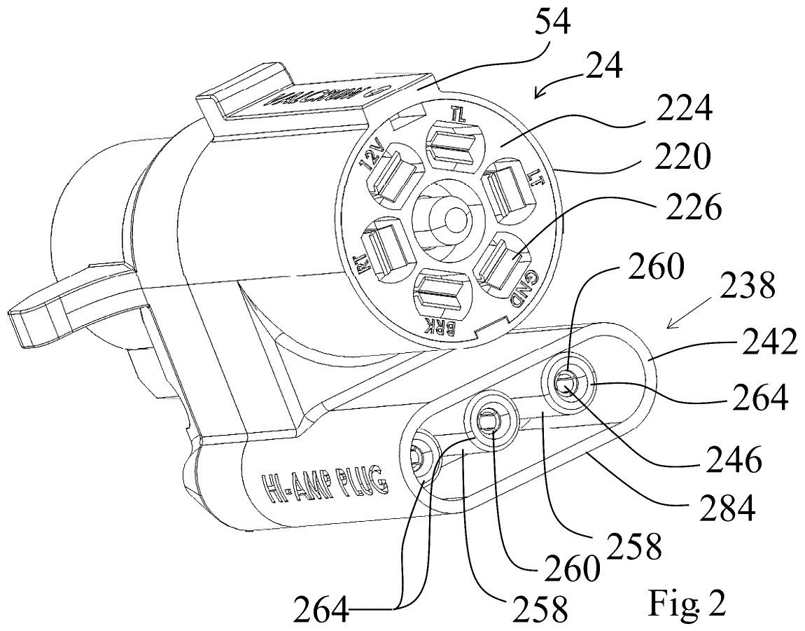

FIG. 1 shows a receptacle 18 that is mateable with the plug 24 (shown in FIG. 2) for the multi-current trailer connector 30 that is the subject of this invention. The receptacle 18 serves as a non-conductive housing that is designed to be mounted on a towing vehicle as has been done with prior art receptacles. The receptacle 18 is not only useful for towing vehicles, but may also be used for recreational vehicles (“RV”) or other vehicles that would be well served to have a connection for transmitting a significant amount of electrical power in a safe manner. The receptacle 18 has a face plate 32 that is a generally planar surface with an outer surface 36 that defines a face that shows outwardly to a user of the receptacle 18. The receptacle 18 has a first socket 38 that extends behind the outer surface 36 of the face plate 32. In the embodiment shown, the first socket includes a plurality of terminals 40 that are offset from the outer surface 36 of the face plate 32. As shown, the terminals 40 in the first socket 38 form the connectors for a 7-way trailer connector. The terminals 40 are for carrying 12 Volts DC and are generally considered low amperage connections. The terminals 40 are electrically connected to the electrical system of the towing vehicle and are generally for ensuring functions on a trailer are simultaneously actuated with those same functions on the towing vehicle. Those functions are typically lighting and braking. The first socket 38 is surrounded by an upstanding collar 44 that stands proud of the outer surface 36 of the face plate 32. The upstanding collar 44 ends at an outer surface 48 that defines its height above the outer surface 36 of the face plate 32. As is typical in a 7-way connector, the first socket 38 has an alignment feature 52 that is a slot that mates with a ridge 54 on the plug 24 when the plug 24 is inserted into the first socket 38. As can be seen, the terminals 40 in the first socket are offset inwardly from the outer surface 36 of the face plate 32.

The receptacle 18 has a second socket 66 that extends into and behind the face plate 32. The second socket 66 has a terminal block 70 that is within the second socket 66. A sidewall 74 circumscribes three protective collars 78. The protective collars 78 are cylindrical and extend into the second socket 66 along with the sidewall 74. The sidewall 74 and protective collars 78 both end at an outer end surface 80 that defines the end of the terminal block 70. The outer end surface 80 is offset and proud of the outer surface 36 of the face plate 32. The outer end surface 80 is offset outwardly of the outer surface 36 in the opposite direction of the first socket 38. The outer end surface 80 of the terminal block 70 is aligned with the outer surface 48 of the upstanding collar 44. As such, the outer end surface 80 and the outer surface 44 of the collar 44 are coplanar. The terminal block 70 is not enclosed and is unobstructed above the outer surface 36. The protective collars 78 are cylindrical walls that are integral with the sidewall 74. The protective collars 78 have gaps 84 between them. Within each of the protective collars 78 is a concentrically located terminal pin 88. Each of the terminal pins 88 provides a separate conducive path to the electrical system to a vehicle on which the receptacle 18 is installed. The terminal pins 88 extend with the protective collars 78 to a distal end 92. The distal end 92 of each terminal pin 88 is rounded and the distal ends 92 of the terminal pins 88 are recessed within the protective collars 78. The distal ends 92 of the terminal pins 88 are offset from the outer end surface 80 within the second socket 66 to be below the outer end surface 80 of the terminal block 70. This recessed location of the distal ends 92 with respect to the outer end surface 80 prevents inadvertent contact with the terminal pins 88. This is important because terminal pins 88 that carry current are live at all times when the vehicle is running and even when the vehicle is not running. The gaps 84 between the protective collars 78 provide additional electrical insulation between the terminal pins 88 beyond the non-conductive material of the entire receptacle 18 that is typically made of plastic. The air within the gaps 84 provides an additional dielectric beyond the protective collars 78 for the terminal pins 88. The gaps 84 are important because pins 88 carry high amperage AC electricity and pins 88 need significant insulation. Additionally, the gaps 84 diminish the likelihood of any electrical bridging due to inadvertent water on the terminal block 70. Such water could provide an electrical path that could provide a short circuit or potentially provide a path for electrical shock. The terminal block 70 is surrounded by a terminal block channel 96. The terminal block channel 96 is defined by the sidewall 74 of the terminal block 70 and an opposing outer sidewall 100 that defines the outer perimeter of the second socket 66. The outer sidewall is connected to the face plate 32.

The receptacle 18 has a spring loaded first door 106 having a cover portion 108 that is designed to cover the first socket 66. A cover sidewall 109 stands upwardly from the cover portion 108. The cover sidewall 109 is cylindrical and mates in a complementary manner with the upstanding collar 44 when the cover portion 108 is in its closed position. The cover portion 108 extends into a tab 112. A spring biases the first door 106 into a closed position that covers the first socket 66. The receptacle 18 has a second door 120 that is hinged to the receptacle 18 and covers the terminal block 70 in its closed position. When the second door 120 is in its closed position and the first door 106 is in its closed positions, the tab 112 on the first door 106 overlaps with the second door 120 in a manner to keep the second door 120 in its closed position.

The plug 24 forms a non-conductive housing that includes a first plug block 220 having an end surface 224 that includes a first group of terminals 226. Each of the terminals 226 are designed to mate with the terminals 40 within the first socket 38. The plug 24 also has a second plug block 238 having an end surface 242. The end surface 224 of the first plug block 220 and the end surface 242 of the second plug block 238 are coplanar with each other. The second plug block 238 has a group of three terminals 246. The terminals 246 are cylindrical and have slits 250 that allow the terminals 246 to receive the terminal pins 88 in the second socket 66 of the receptacle 18. The terminals 246 are housed within terminal bosses 258 having a sidewall 259 and the terminal bosses 258 are within the second plug block 238. Each of the terminals 246 have a distal end 260 that defines the maximum height to which the terminals 246 reach within the second plug block 238. The terminal bosses 258 are cylindrical and terminate at an offset end 264 that is spaced from the distal end 260 of each corresponding terminal 246 contained within the corresponding terminal boss 258. The offset end 264 of each terminal boss 258 has an inclined surface 270 that leads to an aperture 274. The inclined surface 270 provides guidance for a terminal pin 88 to be guided into a corresponding terminal boss 258 so that the distal end 92 of a corresponding terminal pin 88 can connect with a corresponding terminal 246. The offset end 264 of the terminal bosses 258 are recessed inwardly from the end surface 242 of the second plug block 238. The second plug block 238 is defined at its outer extent by a second plug block sidewall 284 that terminates at the end surface 242. The end surface 242 of the second plug block 238 and end surface 224 of the first plug block 220 are aligned, although that is not necessarily required. The second plug block sidewall 284 defines a cavity that houses each of the terminal bosses 258 that are spaced from the second plug block sidewall 284.

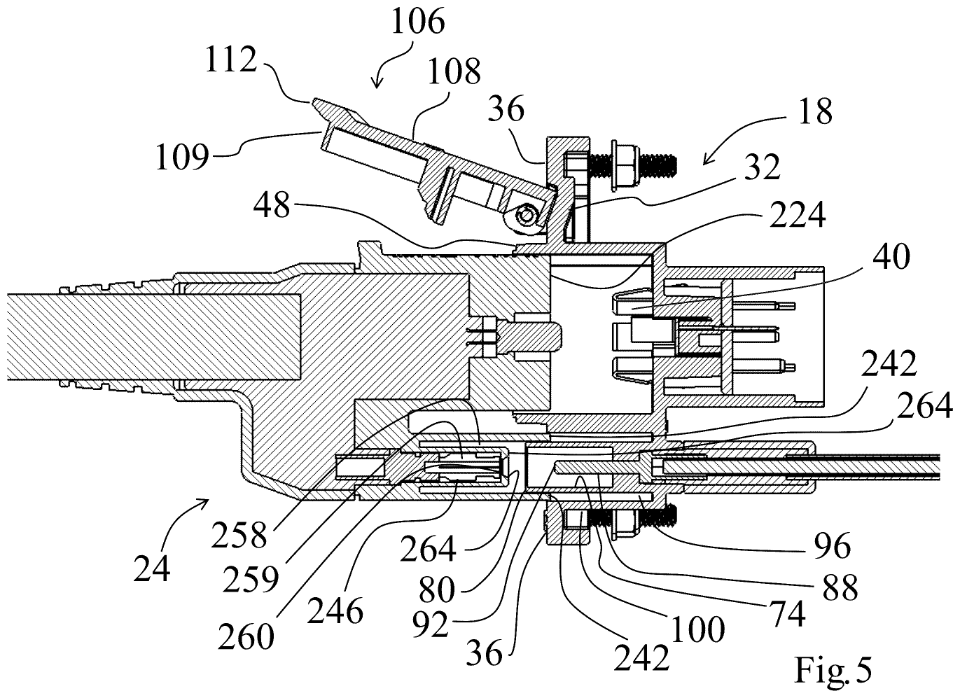

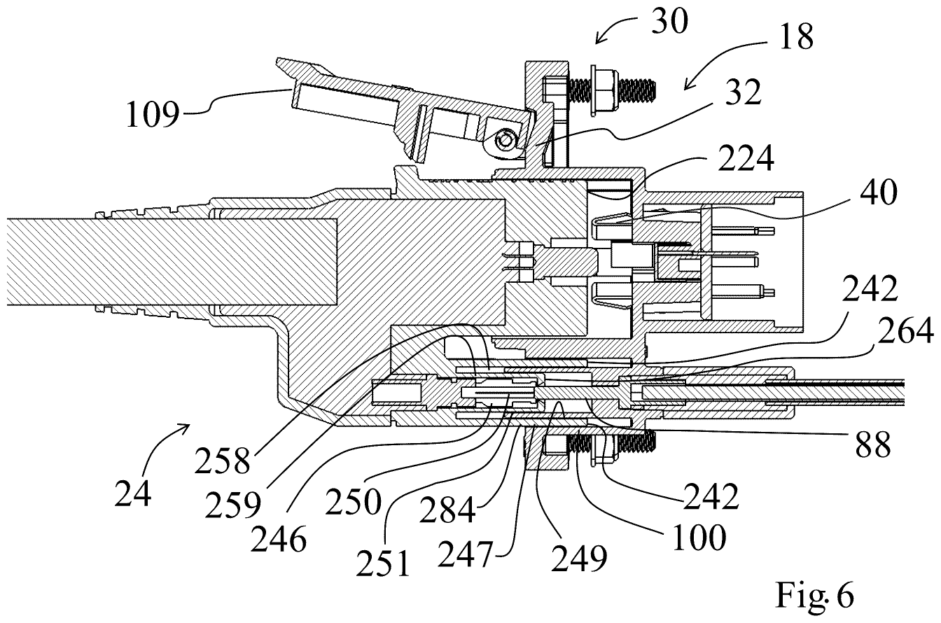

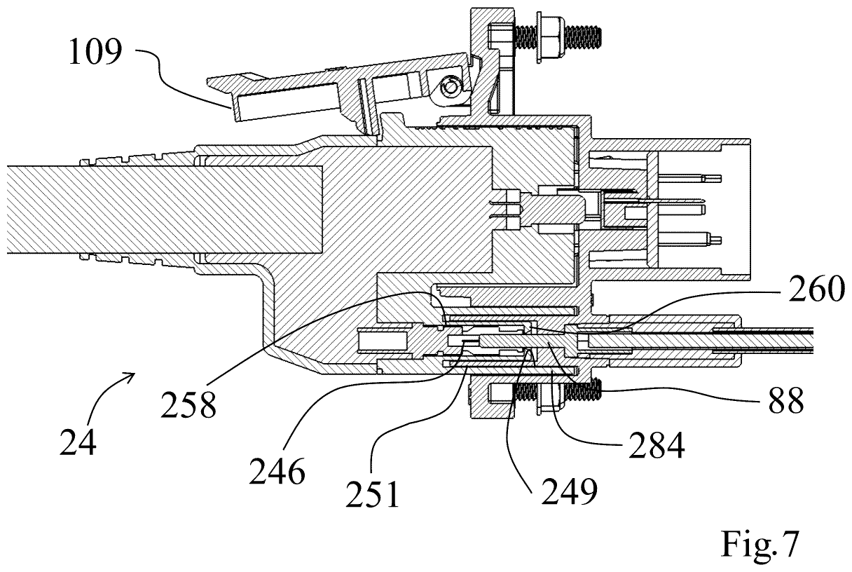

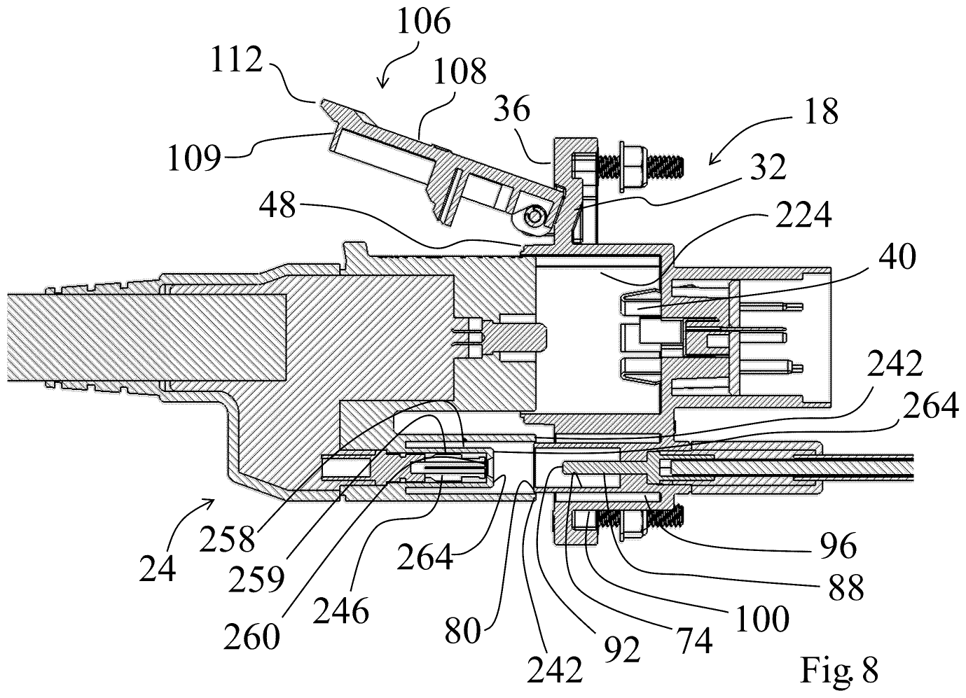

As shown in FIG. 5, the plug 24 is designed to be inserted into the receptacle 18. On the receptacle 18, the outer end surface 80 of terminal block 70 is aligned with the outer surface 48 of the upstanding collar 44. When the plug 24 is inserted into the receptacle 18, the end surface 224 of the first plug block 220 and the end surface 242 of the second plug block sidewall 284 contact the receptacle 18 simultaneously. The first plug block 220 is a complementary fit with the first socket 38. The second plug block 238 has multiple complementary relationships with the second socket 66 of the receptacle 18. The second plug block sidewall 284 fits in a complementary manner over terminal block 70. The simultaneous engagement of the second plug block sidewall 284 over the terminal block 70 and the first plug block 220 within the first socked 38 effectively shrouds the second terminal block 70 from the outside environment and a user inserting the plug 24 into the receptacle 18. When the second plug block sidewall 284 first contacts the terminal block 70, that contact occurs at a location that is offset from the outer surface 36 of the face plate 32. This is shown in FIG. 8. At that point, where the first plug block 220 and second plug block sidewall 284 first make contact with the receptacle 18, the inside of the second plug block sidewall 284 and first plug block 220 telescopically guide the plug 24 into the receptacle 18. At the point of first contact between the second plug block sidewall 284 and the terminal block 70, the terminal pins 88 and terminals 246 are not in contact and no electrical circuit is formed between them. As the plug 24 is further inserted into the receptacle 18, the second plug block sidewall 284 will contact the opposing outer sidewall 100 and the sidewall 74 of the terminal block channel 96. This is shown in FIG. 5. When the second plug block sidewall 284 first contacts the opposing outer sidewall 100 the offset ends 264 of the terminal bosses 258 are spaced from the terminal pins 88. In other words, to describe this relationship, when the end surface 242 of the second plug block sidewall 284 is aligned with the outer surface 36 of the face plate 32 of the receptacle 18, the offset ends 264 of the terminal bosses 258 are spaced from the terminal pins 88. Because the terminal bosses 258 are spaced from the terminal pins 88 at the location when the second plug block sidewall 284 is first inserted into the terminal block channel 96, the terminals 246 do not contact the terminal pins 88. As such, no electrical path is formed when the second plug block sidewall 284 is inserted into the terminal block channel 96 until a predetermined distance of complementary nesting of the second plug block sidewall 284 within the terminal block channel 96. Once, the second plug block sidewall 284 is inserted to a predetermined distance, the distal ends 260 of the terminal 246 will contact terminal pins 88 to form an electrical path going through the plug 24 and receptacle 18. This is shown in FIG. 6 that illustrates electrical contact being made between terminals 246 and terminal pins 88. Only when the end surface 242 of the second plug block sidewall 284 is below the outer surface 36 will an electrical connection be made between pins 88 and terminals 246. This means that no electrical connection will be made between pins 88 and terminals 246 until that connection is securely insulated in multiple places. Only when the second plug block sidewall 284 is located within the terminal block channel 96, will an electrical connection be made between pins 88 and terminals 246. The location where the terminals 246 connect with the terminal pins 88 is a connection point that is well insulated from a user of the plug 24 and receptacle 18. The connection point is shown in FIG. 6. Further secure insulation is shown in FIG. 7, where the second plug block sidewall 284 is fully inserted into the terminal block channel 96.

The order of contact in telescoping engagement between the receptacle 18 and plug 24 are important to functioning of both parts. At the initial contact between the plug 24 and receptacle 18, the second plug block sidewall 284 connects with the terminal block 70 at the sidewall 74 for a first contact. Further sliding of the plug 24 into the receptacle 18 beyond the first contact causes the second plug block sidewall 284 to be located between the sidewall 74 of the terminal block 70 and the outer sidewall 100. In other words, the second plug block sidewall 284 is captured between sidewall 74 and outer sidewall 100 in the terminal block channel 96. This is a second contact between the plug 24 and receptacle 18. Further sliding of the plug 24 into the receptacle causes contact of the terminal pins 88 and the terminals 246 for a third contact that provides an electrical connection across terminal pins 88 and terminals 246. The connection point (where the terminal pins 88 and terminals 246 first make their electrical connection) locates the terminal bosses 258 in a complementary nested alignment with the protective collars 78. Thus, at the connection point the electrically insulative terminal bosses 258 and protective collars 78 form a double insulative cooperative structure. Additionally, the complementary fit of the second plug block sidewall 284 and the sidewall 74 provide an insulating structure. Still further, the second plug block sidewall 284 being fully inserted into the terminal block channel 96 adds even more insulation at the connection point of insertion of the plug 24 into the receptacle 18 because the entire double insulated connection of the terminals 246 and terminal pins, 88 are fully encased by the second plug block sidewall 284. This fully nested relationship that has been described above means that any water would necessarily need to circulate through a torturous path from the outside of the plug 24 and receptacle 18 to find its way into the connection at the connection point of the plug 24 within the receptacle 18. The torturous path would necessarily require water to travel along a first interface 247 that is made by the contact of the second plug block sidewall 284 and the outer sidewall 100 of the second socket 66. The torturous path continues around end surface 242 and to a second interface 249 that is made by the contact of the sidewall 74 of the terminal block 70 and the inside of the second plug block sidewall 284. The torturous path continues around outer end surface 80 of the terminal block 70 to a third interface 251 that is made by the contact of the inside of the protective collars and terminal bosses 258. Further insulation between terminal pins 88 is achieved by the gaps 84 between the protective collars 78 that surround each terminal pin 88. As shown the protective collars 78 are cylindrical, but it is contemplated that the protective collars 78 could be other shapes as well as long as that shape is able to telescopically nest in guiding alignment with the terminal bosses 258. The telescoping alignment described above prevents bending of the terminal pins 88 and allows the smallest diameter pins 88 that can effectively carry the desired current.

The highly insulated nature of the plug 24 and receptacle 18 when the plug 24 is located at its connection point with respect to the receptacle 18 is important because the second plug block 238 is used for carrying high amperage current. The terminals 40 in the receptacle 18 and terminals 226 may engage nearly simultaneously as the connection point in the second socket 66 is reached but this is not critical. Often, the terminal pins 88 in the second socket 66 will carry 110 AC from the vehicle to which the receptacle 18 is affixed. In this case, one of the outer terminal pins 88 will be considered hot, the other outer terminal pin 88 will be a neutral. Thus, the outer terminal pins 88 can complete an AC electrical circuit when connected to the plug 24 when the plug 24 is inserted to its connection point within the receptacle 18. The middle terminal pin 88 is used as a ground. It may be possible for an entire plug (not shown) to resemble just the second plug block 238 alone. In such a configuration of an entire plug consisting of just the second plug block 238 there would be no alignment feature to dictate the orientation within the second socket 66 of the receptacle 18. Having the middle terminal pin 88 being a ground would allow flipping of a plug just consisting of the second plug block 238 to work properly and still be grounded. As shown, the first plug block 220 acts as an alignment feature that demands the second plug block 238 be inserted in a particular orientation.

The configuration of the plug 24 and receptacle 18 enables a high level of electrical insulation from the environment and a user without the necessity of an actively managed system or mechanism to shut off the flow of electricity. This configuration provides a quadruple wall insulated connection across pins 88 and terminals 246 when the plug 24 and receptacle 18 are connected. This quadruple wall insulation includes the outer sidewall 100 of the second socket 66, the second plug block sidewall 284, the sidewall 74, and the sidewall 259 of each terminal boss 258. This is particularly useful to vehicle manufacturers who are not accustomed to providing active power management to receptacles 18 on their vehicles, yet want to provide high amperage connections. The invention is not limited to the description above but may be modified within the scope of the following claims.

What is claimed is:

1. A connector comprising:
a first assembly including a non-conductive housing including a face plate having an outer surface, a first socket extending behind said outer surface of said face plate, said first socket including a plurality of terminals in a location offset from said outer surface of said face plate wherein said terminals are recessed within said first socket, a second socket within said first assembly including a terminal block, said terminal block having a sidewall circumscribing a plurality of protective collars, said sidewall extending outward of said outer surface of said face plate in a direction opposite to that of said first socket, each of said protective collars being connected to said sidewall of said terminal block and each of said protective collars surrounding a terminal pin being located within each said protective collar, said sidewall of said terminal block including an outer end surface being offset from said outer surface of said face plate in a direction opposite said first socket, said terminal block being surrounded by a terminal block channel and said terminal block channel being defined by said sidewall of said terminal block and a second socket sidewall, said terminal block channel being spaced from said first socket; and
a second assembly including a non-conductive housing including a first plug block having an end surface and containing a first group of terminals including a plurality of terminals for providing electrical paths and a second plug block having an end surface and containing a second group of terminals including a plurality of terminals for providing electrical paths, each of said terminals within said first plug block and said second plug block being connected to a wire and said wires being electrically insulated from each other and contained within a cord extending from said second assembly, said second plug block having an outer wall having an inner surface and an outer surface and said outer wall ending at said end surface of said second plug block, outer wall of said second plug block being spaced from and surrounding a plurality of upstanding terminal bosses, each of said terminal bosses terminating at an offset surface that is recessed from said end surface of said end surface of said second plug block, each of said end surfaces of said terminal bosses including an aperture, each said terminal bosses including a terminal adjacent to said aperture for contacting one of terminal pins of said terminal block of said first assembly and forming an electrical connection therewith; an outer sidewall fitting in complementary engagement over said terminal block of said first assembly when said second assembly is engaged with said first assembly thereby substantially shielding said terminal block when said outer sidewall connects with said terminal block, said outer sidewall being connectable to said terminal block above said outer surface of said face plate, said electrical connection of said terminal pins and said terminals within said terminal bosses occurring at a location wherein said outer sidewall completely covers said terminal block.

2. The connector of claim 1, wherein said outer sidewall is below said outer surface of said face plate when said terminal pins contact said terminals within said terminal bosses.

3. The connector of claim 2, wherein said terminal pins are concentrically located within said protective collars.

4. The connector of claim 2, wherein said collars are spaced from each other and have a gap between them.

5. The connector of claim 2, wherein said terminal pins are cylindrical and said terminals within said bosses are cylindrical for receiving said terminal pins in telescoping contact.

6. The connector of claim 2, wherein said terminal pins and said terminals within said bosses contact each other simultaneously with the contact of said terminals in said first socket and said terminals in said first plug block.

7. A connector comprising:
a first assembly including a non-conductive housing including a face plate having an outer surface, a first socket extending behind said outer surface of said face plate, said first socket including a plurality of terminals in a location offset from said outer surface of said face plate wherein said terminals are recessed within said first socket, a second socket within said first assembly including a terminal block, said terminal block having a sidewall surrounds a plurality of terminal pins, said sidewall extending outward of said outer surface of said face plate in a direction opposite to that of said first socket, said sidewall of said terminal block including an outer end surface being offset from said outer surface of said face plate in a direction opposite said first socket, said terminal block being surrounded by a terminal block channel and said terminal block channel being defined by said sidewall of said terminal block and a second socket sidewall, said terminal block channel being spaced from said first socket; and
a second assembly including a non-conductive housing including a first plug block having an end surface and containing a first group of terminals including a plurality of terminals for providing electrical paths and a second plug block having an end surface and containing a second group of terminals including a plurality of terminals for providing electrical paths, said second plug block having an outer wall having an inner surface and an outer surface and said outer wall ending at said end surface of said second plug block, said outer wall of said second plug block being spaced from and surrounding a plurality of upstanding terminal bosses, each of said terminal bosses terminating at an offset surface that is recessed from said end surface of said end surface of said second plug block, each of said end surfaces of said terminal bosses including an aperture, each said terminal bosses including a terminal adjacent to said aperture for contacting one of said terminal pins of said terminal block of said first assembly and forming an electrical connection therewith; said outer sidewall fitting in complementary engagement over said terminal block of said first assembly when said second assembly is engaged with said first assembly thereby substantially shielding said terminal block when said outer sidewall connects with said terminal block, said outer sidewall first telescopically contacting said sidewall of said terminal block when said second assembly is engaged with said first assembly for a first contact of said first and second assemblies, further sliding of said first and second assemblies beyond said first contact causing contact of said outer sidewall between said sidewall of said terminal block and said second socket sidewall for a second contact of said first and second assemblies, further sliding of said first and second assemblies beyond said second contact causing connection of said terminal pins and said terminals in said terminal bosses.

8. The connector of claim 7, wherein said terminal pins are concentrically located within protective collars that are connected to said sidewall of said terminal block.

9. The connector of claim 7, wherein said collars are spaced from each other and have a gap between them.

10. The connector of claim 7, wherein said terminal pins are cylindrical and said terminals within said bosses are cylindrical for receiving said terminal pins in telescoping contact.

11. The connector of claim 7, wherein said terminal pins and said terminals within said bosses contact each other simultaneously with the contact of said terminals in said first socket and said terminals in said first plug block.

12. A connector comprising:
a first assembly including a non-conductive housing including a face plate having an outer surface, a first socket extending behind said outer surface of said face plate, said first socket including a plurality of terminals in a location offset from said outer surface of said face plate wherein said terminals are recessed within said first socket, a second socket within said first assembly including a terminal block, said terminal block having a sidewall surrounds a plurality of terminal pins, said sidewall extending outward of said outer surface of said face plate in a direction opposite to that of said first socket, said sidewall of said terminal block including an outer end surface being offset from said outer surface of said face plate in a direction opposite said first socket, said terminal block being surrounded by a terminal block channel and said terminal block channel being defined by said sidewall of said terminal block and a second socket sidewall, said terminal block channel being spaced from said first socket;
a second assembly including a non-conductive housing including a plug block having an end surface and containing a group of terminals including a plurality of terminals for providing electrical paths, said plug block having an outer wall having an inner surface and an outer surface and said outer wall ending at said end surface of said plug block, said outer wall of said second plug block being spaced from and surrounding a plurality of upstanding terminal bosses, each of said terminal bosses terminating at an offset surface that is recessed from said end surface of said end surface of said plug block, each of said end surfaces of said terminal bosses including an aperture, each said terminal bosses including a terminal adjacent to said aperture for contacting one of said terminal pins of said terminal block of said first assembly and forming an electrical connection therewith; said outer sidewall fitting in complementary engagement over said terminal block of said first assembly when said second assembly is engaged with said first assembly thereby substantially shielding said terminal block when said outer sidewall connects with said terminal block, said outer sidewall first telescopically contacting said sidewall of said terminal block when said second assembly is engaged with said first assembly for a first contact of said first and second assemblies, further sliding of said first and second assemblies beyond said first contact causing contact of said outer sidewall between said sidewall of said terminal block and said second socket sidewall for a second contact of said first and second assemblies, further sliding of said first and second assemblies beyond said second contact causing connection of said terminal pins and said terminals in said terminal bosses.

13. The connector of claim 12, wherein said terminal pins are concentrically located within protective collars that are connected to said sidewall of said terminal block.

14. The connector of claim 12, wherein said collars are spaced from each other and have a gap between them.

15. The connector of claim 12, wherein said terminal pins are cylindrical and said terminals within said bosses are cylindrical for receiving said terminal pins in telescoping contact.
